(19) United States
(12) Patent Application Publication
(10) Pub. No.: US 2024/0072426 A1
(43) Pub. Date: Feb. 29, 2024

(54) ANTENNA AND ELECTRONIC DEVICE INCLUDING THE ANTENNA

(71) Applicant: MEDIATEK INC., Hsinchu City (TW)

(72) Inventors: Nai-Chen LIU, Hsinchu City (TW); Chung-Hsin CHIANG, Hsinchu City (TW); Wun-Jian LIN, Hsinchu City (TW); Shih-Huang YEH, Hsinchu City (TW)

(21) Appl. No.: 18/453,455

(22) Filed: Aug. 22, 2023

Related U.S. Application Data
(60) Provisional application No. 63/373,209, filed on Aug. 23, 2022.

(51) Int. Cl. H01Q 1/36; H01Q 1/12; H01Q 1/46; H01Q 21/06

(52) U.S. Cl. CPC H01Q 1/36; H01Q 1/125; H01Q 1/46; H01Q 21/062

(57) ABSTRACT

An antenna and an electronic device including the antenna are provided. The antenna includes a pair of radiators, a pair of feeding elements, first and second feeding ports. The radiators are located beside a geometric origin and separated from each other. The geometric origin is located between the radiators. The feeding elements are located below the pair of radiators and are configured to feed signals to the radiators. The pair of feeding elements includes a first feeding element and a second feeding element that are separated from each other. The first feeding element has a first geometric configuration. The second feeding element has a second geometric configuration that is asymmetric to the first geometric configuration. The first feeding port is electrically connected to the first feeding element. The second feeding port is separated from the first feeding port and electrically connected to the second feeding element.

### CROSS REFERENCE TO RELATED APPLICATIONS

This application claims the benefit of U.S. Provisional Application No. 63/373,209, filed Aug. 23, 2022, the entirety of which is incorporated by reference herein.

### BACKGROUND OF THE INVENTION

### Field of the Invention

The present disclosure relates to an antenna, and, in particular, to feeding elements of a dipole antenna, and an electronic device including the antenna.

### DESCRIPTION OF THE RELATED ART

Antennas are essential components of all modern electronic devices that require radio-frequency functionality, such as smartphones, tablet computers, and notebook computers. As communication standards evolve to provide faster data transfer rates and higher throughput, the demands placed on antennas are becoming more challenging. For example, to meet requirements of fifth-generation (5G) mobile telecommunication at FR2 (Frequency Range 2) bands with MIMO (multi-input multi-output) of dual-polarization diversity, an antenna needs to support broader bandwidths. It also needs to be able to transmit and receive independent signals of different polarizations (e.g., two signals carrying two different data streams by horizontal polarization and vertical polarization) with high signal isolation between these different polarizations, so as to provide high cross-polarization discrimination (XPD).

Moreover, antennas need to be compact in size, since modern electronic devices need to be slim, lightweight, and portable, and these devices have limited space available for an antenna. Accordingly, antennas need to have a high bandwidth-to-volume ratio representing the amount of bandwidth per unit volume (measured in, e.g., Hz/(mm³)). In order to improve communication with high-end smartphone applications, an antenna module having enhanced performance and a small size is desirable.

### BRIEF SUMMARY OF THE INVENTION

An embodiment of the present disclosure provides an antenna. The antenna includes a pair of radiators, a pair of feeding elements, a first feeding port and a second feeding port. The radiators are located beside a geometric origin and separated from each other. The geometric origin is located between the radiators. The feeding elements are located below the pair of radiators and are configured to feed signals to the radiators. The pair of feeding elements includes a first feeding element and a second feeding element that are separated from each other. The first feeding element has a first geometric configuration. The second feeding element has a second geometric configuration that is asymmetric to the first geometric configuration. The first feeding port is electrically connected to the first feeding element. The second feeding port is separated from the first feeding port and electrically connected to the second feeding element.

An embodiment of the present disclosure provides electronic device including an antenna. The antenna includes a first pair of radiators, a second pair of radiators, a first pair of feeding elements and a second pair of feeding elements. The first pair of radiators includes a first radiator and a second radiator separated from each other. The second pair of radiators includes a third radiator and a fourth radiator separated from each other. The first radiator and the third radiator are arranged at two opposite sides of a second gap. The second radiator and the fourth radiator are arranged at two opposite sides of the second gap. The first radiator and the fourth radiator are arranged at two opposite sides of a first gap. The second radiator and the third radiator are arranged at two opposite sides of the first gap. The first gap and the second gap are intersected. The first pair of feeding elements is located below the first pair of radiators and configured to feed signals to the first pair of radiators. The first pair of feeding elements includes a first feeding element and a second feeding element separated from each other. The first feeding element has a first geometric configuration. The second feeding element has a second geometric configuration asymmetric to the first geometric configuration. The second pair of feeding elements is located below the second pair of radiators and configured to feed signals to the second pair of radiators. The second pair of feeding elements includes a third feeding element and a fourth feeding element separated from each other. The third feeding element has a third geometric configuration. The fourth feeding element has a fourth geometric configuration asymmetric to the third geometric configuration.

### BRIEF DESCRIPTION OF THE DRAWINGS

The present invention can be more fully understood by reading the subsequent detailed description and examples with references made to the accompanying drawings, wherein:

FIG. 1A is three-dimensional (3D) view of an antenna in accordance with some embodiments of the disclosure;

FIG. 1B is a top view of the antenna shown in FIG. 1A in accordance with some embodiments of the disclosure, showing the arrangement of radiators of the antenna;

FIGS. 2A and 2B are plan views of an antenna, showing radiators and feeding elements of the antenna in accordance with some embodiments of the disclosure;

FIG. 2C is a cross-sectional view of FIGS. 2A and 2B, showing the radiators and the feeding elements of the antenna in accordance with some embodiments of the disclosure;

FIG. 2D is a side view of FIGS. 2A and 2B, showing the radiators and the feeding elements of the antenna in accordance with some embodiments of the disclosure;

FIGS. 3A, 3B, 3C, 3D, 3E, 3F, 3G, 3H and 3I are side views of an antenna, showing a pair of radiators and a pair of corresponding feeding elements of the antenna in accordance with some embodiments of the disclosure;

FIGS. 4A, 4B, 4C, 4D and 4E are plan views of portions of a pair of feeding elements, showing configurations of feeding starting portions and the feeding ending portions of transmission lines of the pair of feeding elements of an antenna in accordance with some embodiments of the disclosure;

FIGS. 5A, 5B and 5C are plan views of portions of feeding elements, showing configurations of feeding middle portions of transmission lines of the overlapping feeding elements of an antenna in accordance with some embodiments of the disclosure;

FIGS. 6A, 6B, 6C, 6D, 6E, 6F, 6G, 6H, 6I, 6J, 6K, 6L and 6M are plan views of portions of feeding elements, showing configurations of a feeding starting portion/feeding ending portion of a transmission line of the feeding element of an antenna in accordance with some embodiments of the disclosure; and

FIGS. 7A, 7B, 7C, 7D, 7E, 7F, 7G, 7H, 7I, 7J and 7K are plan views of portions of feeding elements, showing configurations of a feeding middle portion of a transmission line of the feeding element of an antenna in accordance with some embodiments of the disclosure.

### DETAILED DESCRIPTION OF THE INVENTION

The following description is made for the purpose of illustrating the general principles of the invention and should not be taken in a limiting sense. The scope of the invention is best determined by reference to the appended claims.

The inventive concept is described fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. Also, the drawings as illustrated are only schematic and are non-limiting. In the drawings, the size of some of the elements may be exaggerated for illustrative purposes and not drawn to scale. The dimensions and the relative dimensions do not correspond to actual dimensions in the practice of the invention

One current antenna includes multiple pairs of feeding elements for multi-frequency or multi-polarization operations of corresponding pairs of radiators. In each of the pair of feeding elements, the feeding elements are directly connected to each other and have symmetric geometric configurations. For example, the pairs of feeding elements have the symmetric shapes and the same levels of distribution. However, the pair of symmetric feeding elements may result in stronger antenna port-to-port mutual coupling and poor isolation performance. The port-to-port mutual coupling reduces the antenna efficiency and performances in both transmit and receive modes. In order to avoid the aforementioned problems, an antenna having improved feeding elements is desirable.

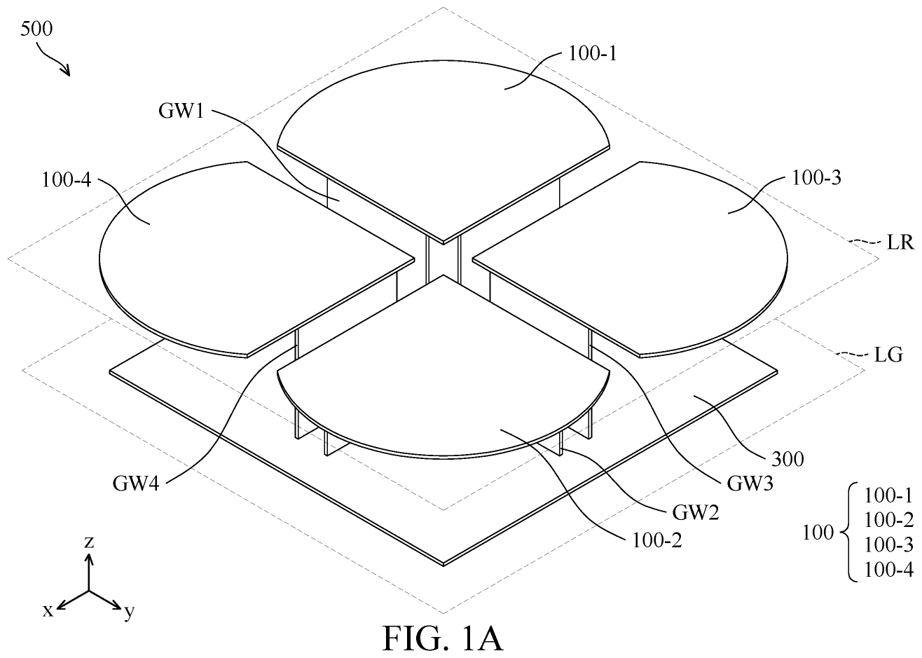

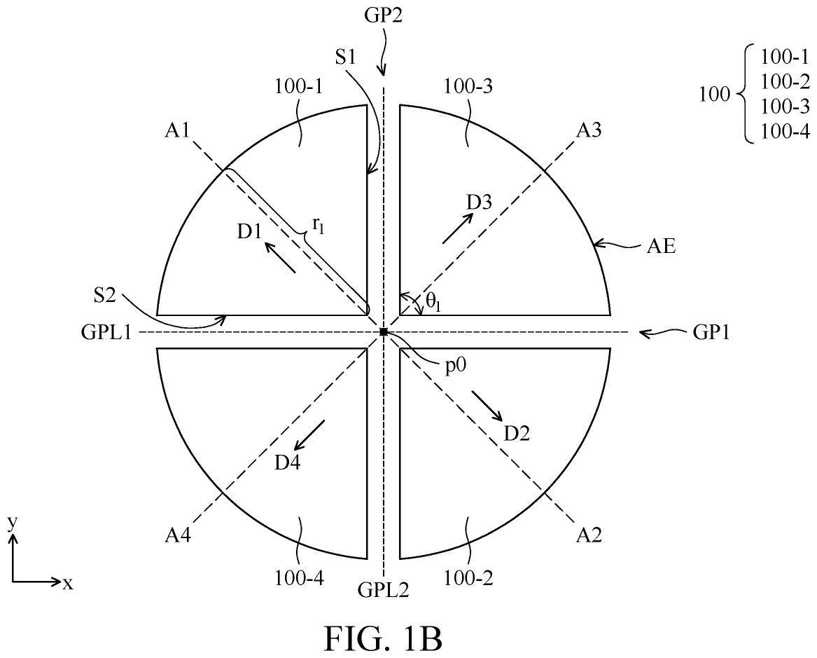

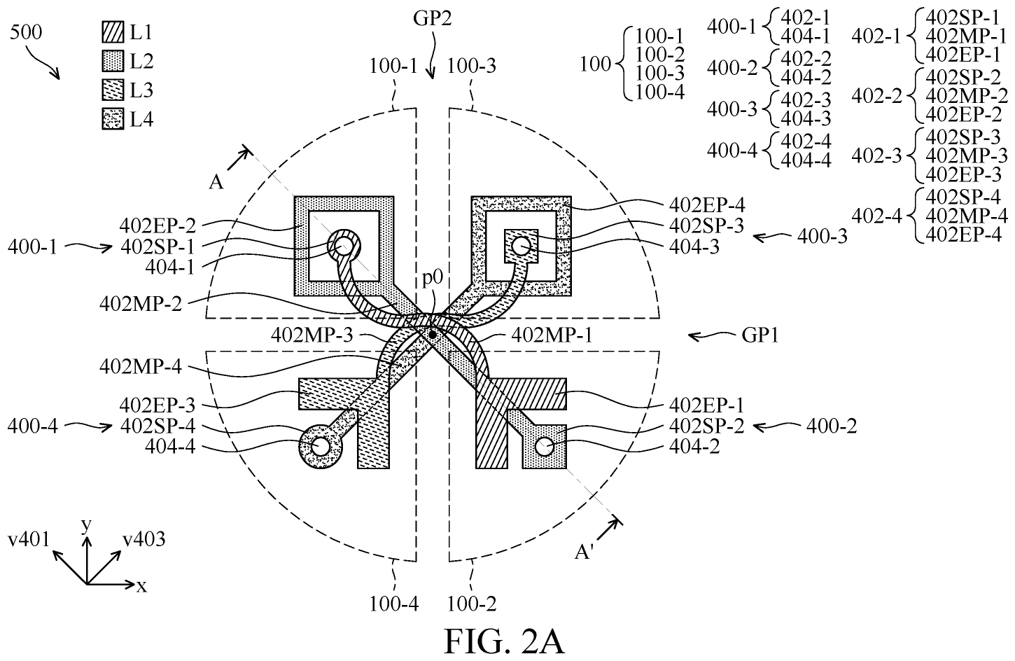

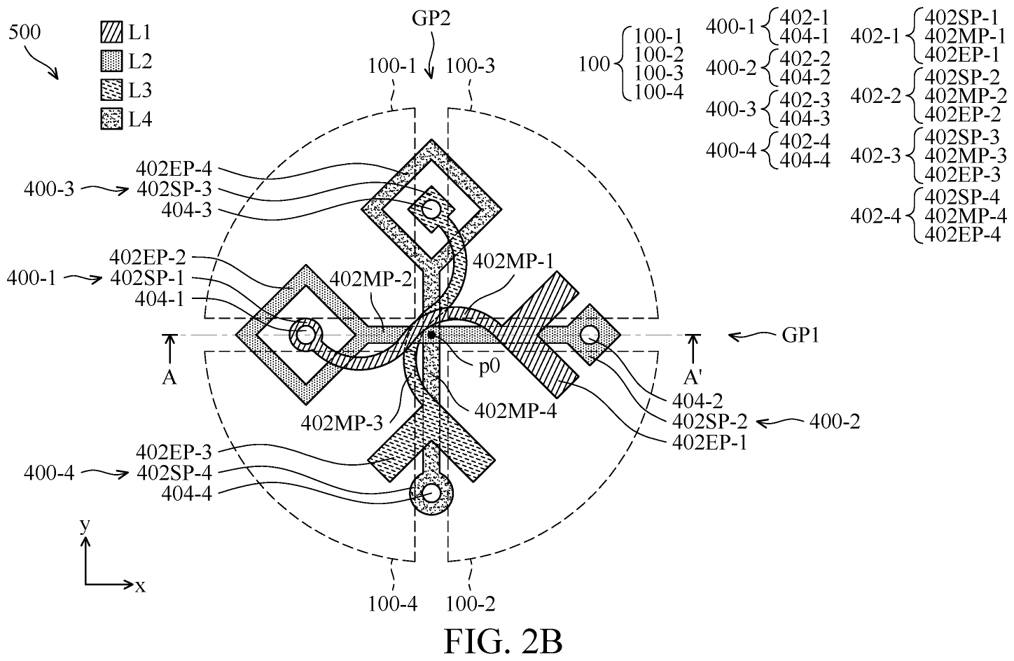

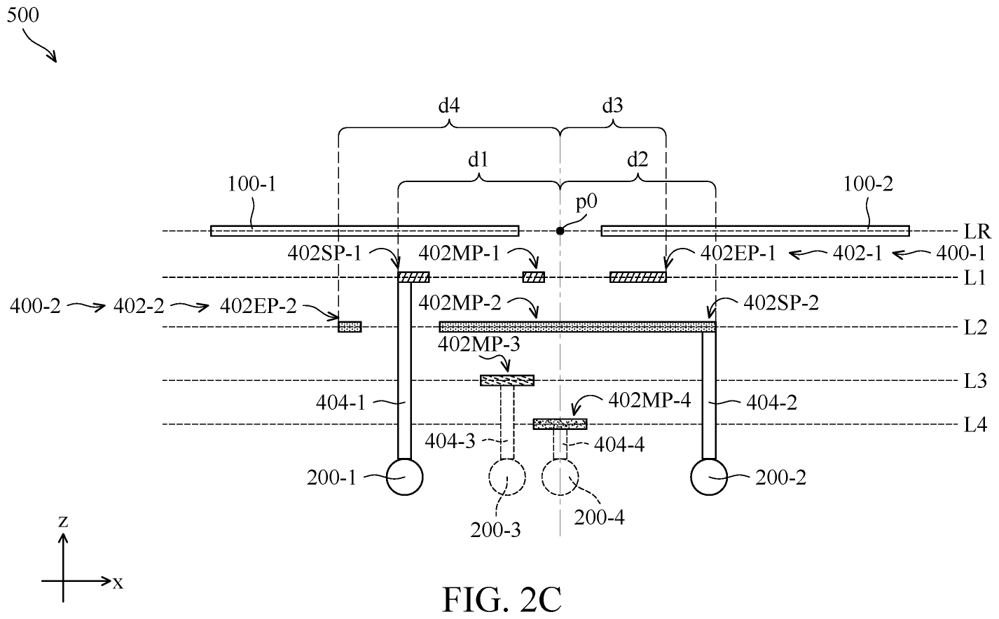

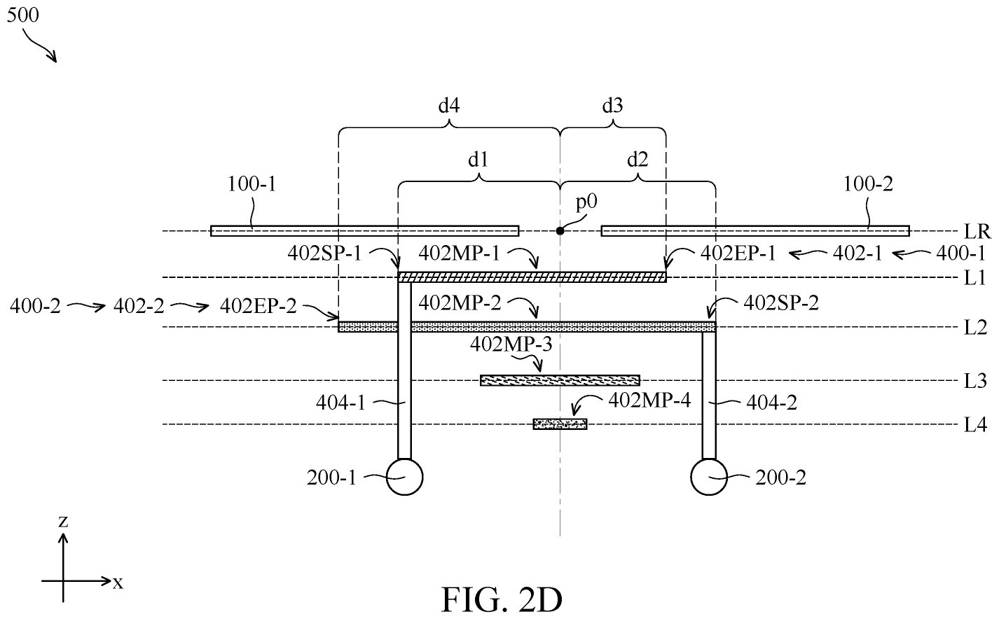

FIG. 1A is a three-dimensional (3D) view of an antenna 500 for multi-broadband (e.g., dual-broadband) and multi-polarization (e.g., dual-polarization) communication in accordance with some embodiments of the disclosure. FIG. 1B is a top view of the antenna 500 shown in FIG. 1A in accordance with some embodiments of the disclosure, showing the arrangement of the radiators 100 FIGS. 2A and 2B are plan views of an antenna 500, showing radiators 100 and feeding elements 400 of the antenna in accordance with some embodiments of the disclosure. FIG. 2C is a cross-sectional view of FIGS. 2A and 2B, showing the radiators 100 and the feeding elements 400 of the antenna 500 in accordance with some embodiments of the disclosures. FIG. 2D is a side view of FIGS. 2A and 2B, showing the radiators 100 and the feeding elements 400 of the antenna 500 in accordance with some embodiments of the disclosure. For illustration, FIG. 1A only shows radiators 100 and a ground plane 300 of the antenna 500. FIG. 1B only shows the radiators 100 of the antenna 500. FIGS. 2A-2D show the radiators 100 and feeding elements 400 of the antenna 500. For illustration, feeding ports 200-3, 200-4 and conductive vias 404-3, 404-4 of the feeding elements 400 are hidden in FIG. 2D. As shown in FIGS. 1A, 1B and 2A-2D, the antenna 500 includes the radiators 100, the ground plane 300 and the feeding elements 400.

In some embodiments, the radiators 100 include radiators 100-1, 100-2, 100-3 and 100-4 separated from each other. In addition, the radiators 100 may jointly function as a plurality of dipoles. Each of the radiators 100-1, 100-2, 100-3 and 100-4 may be a planar conductor positioned at a level LR extending parallel to xy-plane. In addition, each of the radiators 100-1, 100-2, 100-3 and 100-4 may be connected (or electrically connected) to a conductive ground plane 300 which may be a planar conductor positioned at a level LG extending parallel to xy-plane. In addition, level LR is different than level LG. It should be noted that the ground plane 300 shown in FIG. 1A is just to demonstrate how the antenna 500 is disposed on the ground plane 300, not to limit the ground plane 300 to the depicted size and shape. The ground plane 300 parallel to xy-plane may in fact extend wider beyond the size shown in FIG. 1A.

As shown in FIG. 1A, the antenna 500 may further include conductive ground walls GW1, GW2, GW3 and GW4 connecting to the radiators 100-1, 100-2, 100-3 and 100-4 and the ground plane 300. The ground walls GW1, GW2, GW3 and GW4 corresponding to the radiators 100-1, 100-2, 100-3 and 100-4 may extend downward along negative z-direction from bottom surfaces of the radiators 100-1, 100-2, 100-3 and 100-4 to connect the ground plane 300.

As shown in FIG. 1B, on xy-plane, projections of the radiators 100-1 to 100-4 may surround a geometric origin p0 and may face toward four different directions D1, D2, D3 and D4. For example, the directions D1, D2, D3 and D4 may respectively be 135, 315 45 and 225 degrees rotated from x-direction. The radiators 100-1 to 100-4 may be separated by gaps GP1 and GP2 respectively extending along geometric lines GPL1 and GPL2. For example, the radiators 100-1 and 100-3 may be arranged at two opposite sides of the gap GP2, the radiators 100-1 and 100-4 may be arranged at two opposite sides of the gap GP1, etc. Geometry (shapes, structure and sizes) of the radiators 100-1 to 100-4 may substantially be the same, or may have differences (e.g., for feeding, routing and/or mechanical design consideration, etc.) and/or variations (e.g., due to limited precision and accuracy of manufacture, etc.).

As shown in FIG. 1B, each of the radiators 100-1, 100-2, 100-3 and 100-4 may be formed from the sector-shaped radiator having a radius of r₁ and a central angle of 90 degrees. In some embodiments, each of the radiators 100-1, 100-2, 100-3 and 100-4 has edges S1, S2 and an arc edge AE in a top view as shown in FIG. 1B. In some embodiments, the edges S1, S2 extend along geometric lines GPL2 and GPL1. As shown in FIG. 1B, an angle θ₁ between the edges S1, S2 (i.e., the central angle of the arc edge AE) may be equal to 90 degrees. However, the shape of the radiators 100-1, 100-2, 100-3 and 100-4 is not limited to the disclosed embodiments.

In some embodiments, one or more of the radiators 100-1, 100-2, 100-3 and 100-4 may have symmetrical shapes. For example, in the radiator 100-1, the edges S1, S2 may be symmetrical along an axis A1 that is parallel to a radial direction of the radius r₁ and intersects the middle point of the arc edge AE. Therefore, the axis A1 may serve as the axis of symmetry A1 of the radiator 100-1. Similarly, the radiators 100-2, 100-3 and 100-4 may have axes of symmetry A2, A3 and A4. Angles between the axes of symmetry A2, A3 and A4 and the axis of symmetry A1 may respectively be 180, 270 and 90 degrees. In some embodiments, one or more of the radiators 100-1, 100-2, 100-3 and 100-4 may have asymmetrical shapes. For example, the edges S1, S2 of the radiator 100-1 may be asymmetrical along the axis A1 that is parallel to the radial direction of the radius r₁ and intersects the middle point of the arc edge AE.

In some embodiments, the adjacent radiators are symmetrical along the geometric line GPL1 of the gap GP1 or the geometric line GPL2 of the separation gap GP2. For example, the radiators 100-1 and 100-3 separated by the gap GP2 may be symmetrical along the geometric line GPL2. The radiators 100-1 and 100-4 separated by the gap GP1 may be symmetrical along the geometric line GPL1. The radiators 100-2 and 100-4 separated by the gap GP2 may be symmetrical along the geometric line GPL2. The radiators 100-2 and 100-3 separated by the gap GP1 may be symmetrical along the geometric line GPL1. In some other embodiments, the adjacent radiators may be asymmetrical along the geometric line GPL1 of the gap GP1 or the geometric line GPL2 of the separation gap GP2.

In some embodiments, the adjacent radiators are symmetrical along axes of symmetry A1, A2, A3 and A4. For example, the radiator 100-1 and the radiator 100-2 may be symmetrical along the axis of symmetry A3 (or the axis of symmetry A4). The radiator 100-3 and the radiator 100-4 may be symmetrical along the axis of symmetry A1 (or the axis of symmetry A2). In some embodiments, the adjacent radiators are asymmetrical along axes of symmetry A1, A2, A3 and A4. For example, the radiator 100-1 and the radiator 100-2 may be asymmetrical along the axis of symmetry A3 (or the axis of symmetry A4). The radiator 100-3 and the radiator 100-4 may be asymmetrical along the axis of symmetry A1 (or the axis of symmetry A2).

FIGS. 2A and 2B are plan views of the antenna 500, showing the radiators 100 and the feeding elements 400 of the antenna 500 in accordance with some embodiments of the disclosure. For clearly showing the configurations of the feeding elements 400, the radiators 100-1 to 100-4 are hidden and the dashed are used to show the hidden radiators 100-1 to 100-4. FIG. 2C is a cross-sectional view of FIG. 2A along the line A-A′, FIG. 2D is a side view of FIG. 2A, showing the radiators 100 and the feeding elements 400 of the antenna 500 in accordance with some embodiments of the disclosure. As shown in FIGS. 2A, 2B, 2C and 2D, the feeding elements 400 include feeding elements 400-1, 400-2, 400-3 and 400-4 separated from each other and located below the radiators 100-1, 100-2, 100-3 and 100-4 for feeding signals to the radiators 100-1, 100-2, 100-3 and 100-4. In addition, the separated feeding elements 400-1, 400-2, 400-3 and 400-4 may be electrically connected to feeding ports 200-1, 200-2, 200-3 and 200-4 separated from one another, respectively.

In some embodiments as shown in FIGS. 2A, 2C and 2D, the feeding ports 200-1, 200-2, 200-3 and 200-4 are disposed directly below the corresponding radiators 100-1, 100-2, 100-3 and 100-4. The feeding ports 200-1, 200-2, 200-3 and 200-4 may overlap the corresponding radiators 100-1, 100-2, 100-3 and 100-4, respectively. The feeding element 400-1 may extend from the radiator 100-1 to the radiator 100-2 parallel to a direction v401 of the line passing through a projection of the feeding port 200-1 and a projection of the feeding port 200-2 on xy-plane. The feeding element 400-2 may extend from the radiator 100-2 to the radiator 100-1 parallel to the direction v401. The feeding element 400-3 may extend from the radiator 100-3 to the radiator 100-4 parallel to a direction v403 of the line passing through a projection of the feeding port 200-3 and a projection of the feeding port 200-4 on xy-plane. The feeding element 400-4 may extend from the radiator 100-4 to the radiator 100-3 parallel to the direction v403.

In some embodiments, the feeding elements 400-1 to 400-4 may cross an intersection of the gaps GP1 and GP2. The feeding elements 400-1 and 400-2 may extend in the direction v401 of the line passing through a projection of the feeding port 200-1 and a projection of the feeding port 200-2 on xy-plane. The feeding elements 400-3 and 400-4 may extend in the direction v403 of the line passing through a projection of the feeding port 200-3 and a projection of the feeding port 200-4 on xy-plane. For example, in an embodiment, the direction v401 may substantially be 45 degrees rotated from y-direction, and the direction v403 may substantially be 45 degrees rotated from x-direction. By the feeding elements 400-1 and 400-2, the radiators 100-1 and 100-2 may respectively function as two opposite poles of a first dipole for a polarization along the direction v401, and the radiators 100-3 and 100-4 may respectively function as two opposite poles of a second dipole for the polarization along the direction v403. Similarly, by the feeding elements 400-3 and 400-4 shown in FIG. 2A, the radiators 100-3 and 100-4 may respectively function as two opposite poles of a third dipole for a polarization along the direction v403, and the radiators 100-1 and 100-2 may respectively function as two opposite poles of a fourth dipole for the polarization along the direction v403

In some embodiments as shown in FIGS. 2B, 2C and 2D, the feeding ports 200-1, 200-2, 200-3 and 200-4 are disposed below the corresponding radiators 100-1, 100-2, 100-3 and 100-4. The feeding ports 200-1, 200-2, 200-3 and 200-4 may be exposed from gaps GP1 and GP2 between the radiators 100-1, 100-2, 100-3 and 100-4 in a plan view as shown in FIG. 2C. The feeding element 400-1 may extend from the feeding port 200-1 toward the feeding port 200-2 along the geometric line GPL1. The feeding element 400-2 may extend from the feeding port 200-2 toward the feeding port 200-1 along the geometric line GPL1. The feeding element 400-3 may extend from the feeding port 200-3 toward the feeding port 200-4 along the geometric line GPL2. The feeding element 400-4 may extend from the feeding port 200-4 toward the feeding port 200-3 along the geometric line GPL2.

As shown in FIG. 2B, in some embodiments, the feeding elements 400-1 and 400-2 may extend across the gap GP2 along the gap GP1. The feeding elements 400-3 and 400-4 may extend across the gap GP1 along the gap GP2. By the feeding elements 400-1 and 400-2 shown in FIG. 2B, the radiators 100-1 and 100-4 may jointly function as one pole of a first dipole for a polarization along x-direction, while the radiators 100-2 and 100-3 may jointly function as an opposite pole of the first dipole. By the feeding elements 400-3 and 400-4 shown in FIG. 2B, the radiators 100-1 and 100-3 may jointly function as one pole of a second dipole for a polarization along y-direction, while the radiators 100-2 and 100-4 may jointly function as an opposite pole of the second dipole.

In other words, a pair of feeding elements 400-1 and 400-2 may be located below a pair of radiators 100-1 and 100-2. A pair of feeding elements 400-3 and 400-4 may be located below a pair of radiators 100-3 and 100-4. In some embodiments, the geometric configuration of the feeding element 400-1 is asymmetric to the geometric configuration of the feeding element 400-2, and vice versa. In some embodiments, the geometric configuration of the feeding element 400-3 is asymmetric to the geometric configuration of the feeding element 400-4, and vice versa. In some embodiments, the geometric configurations of the feeding elements 400-1, 400-2, 400-3 and 400-4 includes the shape in the plan view, the levels of distribution, the distances from a projection of a feeding starting section or a projection of a feeding ending section of feeding elements 400-1 and 400-2 on xy-plane to a projection of the geometric origin p0 on xy-plane, the distances from projections of conductive vias connected to the feeding ports on xy-plane to the projection of the geometric origin p0 on xy-plane or a combination thereof and would be described fully hereinafter. In some embodiments, the geometric origin p0 is a middle point of an intersection of the gaps GP1 and GP2.

In the pair of feeding elements 400-1 and 400-2, the feeding element 400-1 includes a transmission line 402-1 and a conductive via 404-1. The transmission line 402-1 is positioned at least at a level L1 and extending from the feeding port 200-1 toward the second feeding port 200-2. In addition, the conductive via 404-1 of a vertical height H1 (substantially along z-direction) connected between the feeding port 200-1 and the transmission line 402-1. The feeding element 400-2 includes a transmission line 402-2 and a conductive via 404-2. The transmission line 402-2 is positioned at least at a level L2 different from the level L1 and extending from the feeding port 200-3 toward the second feeding port 200-1. In addition, the conductive via 404-2 of a vertical height H2 different from the vertical height H1 connected between the feeding port 200-2 and the transmission line 402-2.

Similarly, in the pair of feeding elements 400-3 and 400-4, the feeding element 400-1 includes a transmission line 402-3 and a conductive via 404-3. The transmission line 402-3 is positioned at least at a level L3 different from the levels L1, L2 and extending from the feeding port 200-3 toward the second feeding port 200-4. In addition, the conductive via 404-3 of a vertical height H3 connected between the feeding port 200-3 and the transmission line 402-3. The feeding element 400-4 includes a transmission line 402-4 and a conductive via 404-4. The transmission line 402-4 is positioned at least at a level L4 different from the level L3 and extending from the feeding port 200-4 toward the second feeding port 200-3. In addition, the conductive via 404-4 of a vertical height H4 different from the vertical height H3 connected between the feeding port 200-4 and the transmission line 402-4.

As shown in FIGS. 2A-2C, the transmission line 402-1 of the feeding element 400-1 may have a feeding starting portion 402SP-1, a feeding middle portion 402MP-1 and a feeding ending portion 402EP-1. The feeding starting portion 402SP-1 and the feeding ending portion 402EP-1 are positioned at opposite ends of the transmission line 402-1. The feeding starting portion 402SP-1 may be directly connected to the conductive via 404-1. The feeding ending portion 402EP-1 may be away from the feeding port 200-1 and close to the feeding port 200-2. In addition, the feeding middle portion 402MP-1 is interposed between the feeding starting portion 402SP-1 and the feeding ending portion 402EP-1. Similarly, the transmission line 402-2 of the feeding element 400-2 may have a feeding starting portion 402SP-2, a feeding middle portion 402MP-2 and a feeding ending portion 402EP-2. The feeding starting portion 402SP-2 and the feeding ending portion 402EP-2 are positioned at opposite ends of the transmission line 402-2. The feeding starting portion 402SP-2 may be directly connected to the conductive via 404-2. The feeding ending portion 402EP-2 may be away from the feeding port 200-2 and close to the feeding port 200-1. In addition, the feeding middle portion 402MP-2 is interposed between the feeding starting portion 402SP-2 and the feeding ending portion 402EP-2.

In some embodiments, the feeding starting portion 402SP-1 and the feeding ending portion 402EP-1 have different shapes in a plan view. For example, the feeding starting portion 402SP-1 may have a circular shape, and the feeding ending portion 402EP-1 may have an inverse L-shape in the plan view as shown in FIGS. 2A and 2B. In some embodiments, the feeding starting portion 402SP-1 and the feeding starting portion 402SP-2 have different shapes in a plan view. In some embodiments, the feeding starting portion 402SP-1 may have a circular shape, and the feeding ending portion 402SP-2 may have a square shape in the plan view as shown in FIGS. 2A and 2B. In some embodiments, the feeding starting portion 402SP-1 does not overlap the feeding ending portion 402EP-2 in a plan view as shown in FIGS. 2A and 2B. Therefore, the feeding element 400-1 may have a first projection (having the same shape as that of the feeding element 400-1 shown in FIGS. 2A and 2B) in a direction (i.e., z-direction) perpendicular to the pair of radiators 100-1 and 100-2. In addition, the feeding element 400-2 may have a second projection (having the same shape as that of the feeding element 400-1 shown in FIGS. 2A and 2B) in the direction that is perpendicular to the pair of radiators 100-1 and 100-2. In some embodiments, the first projection and the second projection partially overlap each other rather than completely overlap each other.

In some embodiments, a distance d1 between the projection of the geometric origin p0 and a projection of the feeding starting portion 402SP-1 on xy-plane is different from a distance d2 between the projection of geometric origin p0 and a projection of the feeding starting portion 402SP-2 on xy-plane (the distances d1 and d2 are labeled in the cross-sectional view shown in FIG. 2C). In some embodiments, a distance d3 between the projection of the geometric origin p0 and a projection of the feeding ending portion 402EP-1 on xy-plane is different from a distance d4 between the projection of the geometric origin p0 and a projection of the feeding ending portion 402EP-2 on xy-plane (the distances d3 and d4 are labeled in the cross-sectional view shown in FIG. 2C).

In some embodiments, the configurations of feeding starting portions and feeding ending portions of the pair of feeding elements 400-3 and 400-4 may be the same or similar as those of the feeding starting portions 402SP-1, 402SP-2 and the feeding ending portions 402EP-1, 402EP-2 of the pair of feeding elements 400-1 and 400-2 and the details are not repeated herein for brevity.

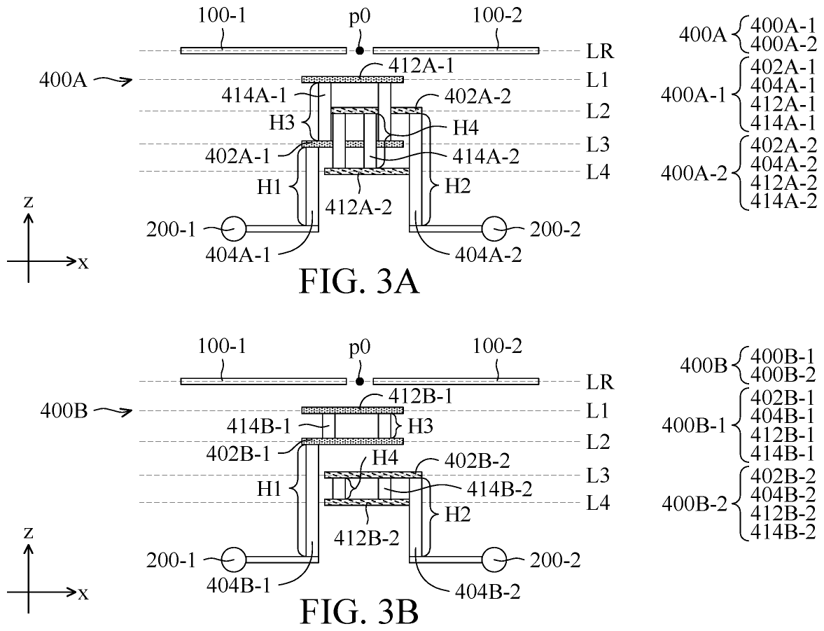

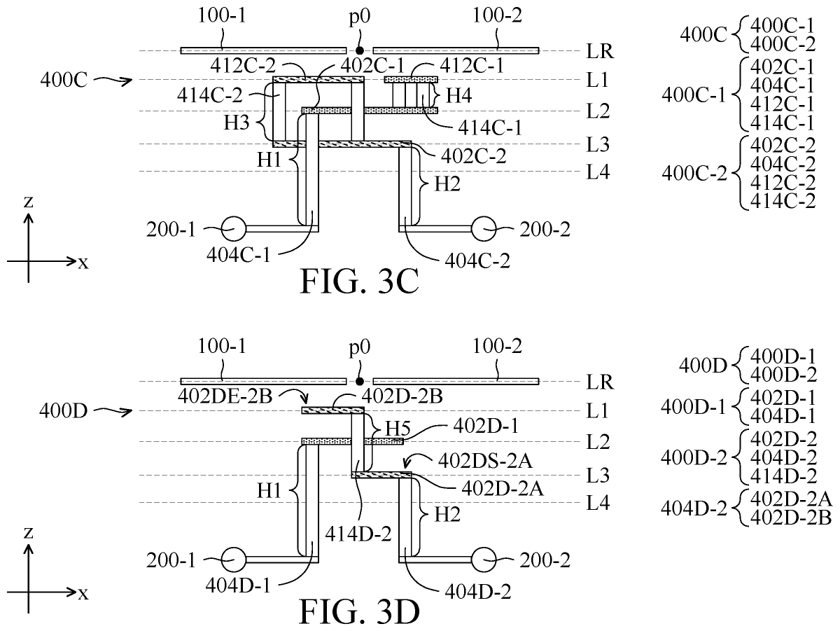

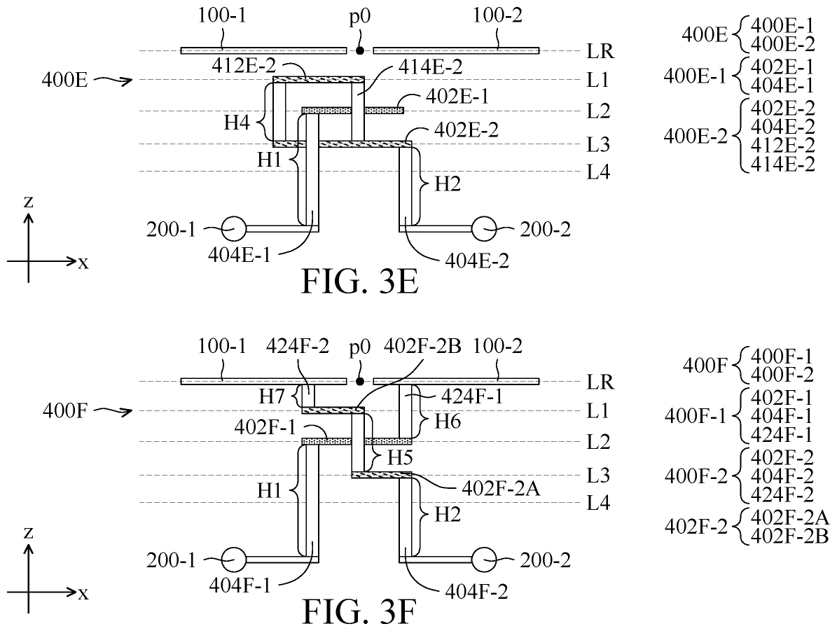

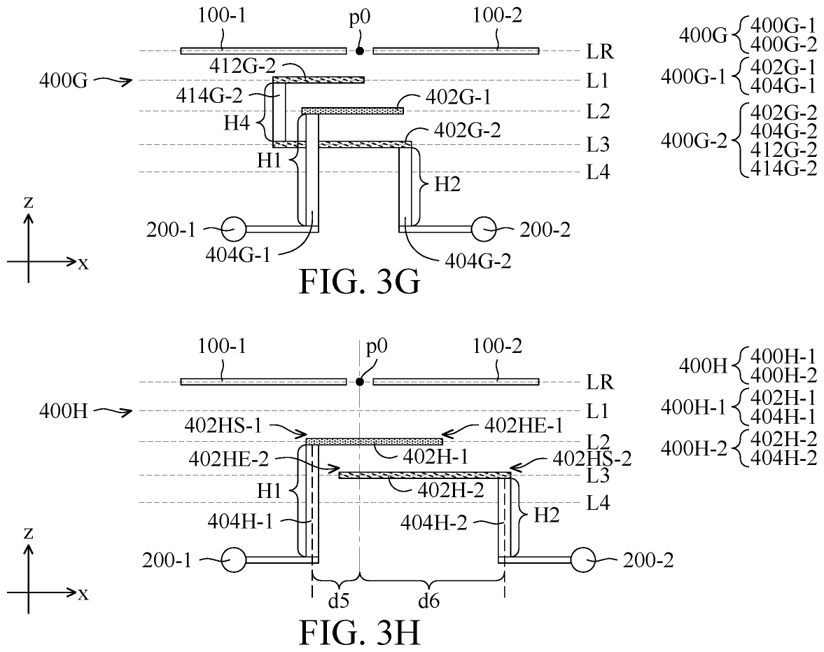

In some embodiments, the geometric configuration of the feeding elements 400-1 and 400-2 are asymmetric in the geometric configuration of the levels of distribution and/or the distances from a projection of the feeding starting portion or a projection of the feeding ending portion to the projection of the geometric origin p0 on xy-plane. In some embodiments, when the feeding elements 400A-1 and 400A-2 include multi-layer structures comprising multiple transmissions, the distances are defined as the farthest distances from the feeding starting portion or the feeding ending portion of the transmission line of the feeding elements 400-1 and 400-2 to the geometric origin p0 in a plan view. FIGS. 3A, 3B, 3C, 3D, 3E, 3F, 3G, 3H and 3I are side views of the antenna, showing the pair of radiators 100-1, 100-2 and corresponding feeding elements 400A, 400B, 400C, 400D, 400E, 400F, 400G, 400H and 400I of the antenna 500 in accordance with some embodiments of the disclosure. For illustration, the radiators 100-3, 100-4 and the feeding elements 400-3, 400-4 are hidden in FIGS. 3A to 3I.

As shown in FIG. 3A, the feeding element 400A includes a pair of feeding elements 400A-1 and 400A-2. The transmission lines of the asymmetric feeding elements 400A-1 and 400A-2 include dual-layer structures distributed at alternating levels. For example, the feeding elements 400A-1 may include transmission lines 402A-1 and 412A-1 and conductive vias 404A-1 and 414A-1. The transmission lines 402A-1 and 412A-1 are positioned at different levels L3 and L1. The transmission line 402A-1 is electrically connected to the feeding port 200-1 by the conductive via 404A-1 having a vertical height H1. The transmission line 412A-1 overlaps the transmission line 402A-1 in the z-direction. Therefore, the transmission line 412A-1 may be disposed between the radiators 100-1 and 100-2 and the transmission line 402A-1 in the z-direction. In addition, the transmission line 412A-1 is electrically connected to the transmission line 402A-1 by the conductive vias 414A-1 having a vertical height H3 that is the same or different than vertical height H1. For example, the feeding elements 400A-2 may include transmission lines 402A-2 and 412A-2 and conductive vias 404A-2 and 414A-2. The transmission lines 402A-2 and 412A-2 are positioned at different levels L2 and L4 and alternate with the transmission lines 402A-1 and 412A-1 positioned at the levels L1 and L3. In addition, the transmission lines 402A-1 and 412A-1 may overlap the transmission lines 402A-2 and 412A-2 in the z-direction. The transmission line 402A-2 is electrically connected to the feeding port 200-2 by the conductive via 404A-2 having a vertical height H2 that is different than vertical height H1. The transmission line 412A-2 overlaps the transmission line 402A-2 in the z-direction. Therefore, the transmission line 402A-2 may be disposed between the radiators 100-1 and 100-2 and the transmission line 412A-2 in the z-direction. The transmission line 402A-1 may be disposed between the transmission line 402A-2 and the transmission line 412A-2 in the z-direction. The transmission line 412A-2 may be disposed between the transmission line 402A-1 and the transmission line 412A-1 in the z-direction. In addition, the transmission line 412A-2 is electrically connected to the transmission line 402A-2 by the conductive vias 414A-2 having a vertical height H4 that is the same or different than vertical height H3. In some embodiments, the transmission lines 402A-1 and 412A-1 of the feeding element 400A-1 and the transmission lines 402A-2 and 412A-2 of the feeding element 400A-2 are asymmetric in the geometric configuration of the levels of distribution. In some embodiments, the conductive via 404A-1 of the feeding element 400A-1 and the conductive via 404A-2 of the feeding element 400A-2 are asymmetric in the geometric configuration of the vertical heights.

As shown in FIG. 3B, the feeding element 400B includes a pair of feeding elements 400B-1 and 400B-2. The transmission lines of the asymmetric feeding elements 400B-1 and 400B-2 include dual-layer structures distributed at adjacent levels. For example, the feeding elements 400B-1 may include transmission lines 402B-1 and 412B-1 and conductive vias 404B-1 and 414B-1. The transmission lines 402B-1 and 412B-1 are positioned at adjacent levels L2 and L1. The transmission line 402A-1 is electrically connected to the feeding port 200-1 by the conductive via 404B-1 having a vertical height of H1. The transmission line 412B-1 overlaps the transmission line 402B-1 in the z-direction. Therefore, the transmission line 412B-1 may be disposed between the radiators 100-1, 100-2 and the transmission line 402B-1 in the z-direction. In addition, the transmission line 412B-1 is electrically connected to the transmission line 402B-1 by the conductive vias 414B-1 having a vertical height H3 that is the same or different than vertical height H1. For example, the feeding elements 400B-2 may include transmission lines 402B-2 and 412B-2 and conductive vias 404B-2 and 414B-2. The transmission lines 402B-2 and 412B-2 are positioned at adjacent levels L3 and L4 and below the transmission lines 402B-1 and 412B-1 at adjacent levels L1 and L2. In addition, the transmission lines 402B-1 and 412B-1 may overlap the transmission lines 402B-2 and 412B-2 in the z-direction. The transmission line 402B-2 is electrically connected to the feeding port 200-2 by the conductive via 404B-2 having a vertical height H2 that is different than vertical height H1. The transmission line 412B-2 overlaps the transmission line 402B-2 in the z-direction. Therefore, the transmission line 402B-2 may be disposed between the radiators 100-1, 100-2 and the transmission line 412B-2 in the z-direction. In addition, the transmission line 412B-2 is electrically connected to the transmission line 402B-2 by the conductive vias 414B-2 having a vertical height H4 that is the same or different than vertical height H3. In some embodiments, the transmission lines 402B-1 and 412B-1 of the feeding element 400B-1 and the transmission lines 402B-2 and 412B-2 of the feeding element 400B-2 are asymmetric in the geometric configuration of the levels of distribution. In some embodiments, the conductive via 404B-1 of the feeding element 400B-1 and the conductive via 404B-2 of the feeding element 400B-2 are asymmetric in the geometric configuration of the vertical heights.

As shown in FIG. 3C, the feeding element 400C includes a pair of feeding elements 400C-1 and 400C-2. The transmission lines of the asymmetric feeding elements 400C-1 and 400C-2 include dual-layer structures distributed at alternating levels, and the transmission lines of the asymmetric feeding elements closest to the radiators 100-1 and 100-2 may be positioned at the same level. For example, the feeding elements 400C-1 may include transmission lines 402C-1 and 412C-1 and conductive vias 404C-1 and 414C-1. The transmission lines 402C-1 and 412C-1 are positioned at adjacent levels L2 and L1. The transmission line 402C-1 is electrically connected to the feeding port 200-1 by the conductive via 404C-1 having a vertical height of H1. The transmission line 412C-1 partially overlaps the transmission line 402A-1 in the z-direction. Therefore, the transmission line 412C-1 may be disposed between the radiators 100-1 and 100-2 and the transmission line 402C-1 in the z-direction. In addition, the transmission line 412C-1 is electrically connected to the transmission line 402C-1 by the conductive vias 414C-1 having a vertical height H3 that is the same or different than vertical height H1. For example, the feeding elements 400C-2 may include transmission lines 402C-2 and 412C-2 and conductive vias 404C-2 and 414C-2. The transmission lines 402C-2 and 412C-2 are positioned at different levels L3 and L1. In addition, the transmission lines 412C-1 and 412C-2 are positioned side-by side at the same level L1. The transmission line 402C-2 is electrically connected to the feeding port 200-2 by the conductive via 404C-2 having a vertical height H2 that is different than vertical height H1. The transmission line 412C-2 partially overlaps the transmission line 402C-2 in the z-direction. Therefore, the transmission line 402C-2 may be disposed between the radiators 100-1, 100-2 and the transmission line 412C-2 in the z-direction. The transmission line 402C-1 may be disposed between the transmission line 402C-2 and the transmission line 412C-2 in the z-direction. In addition, the transmission line 412C-2 is electrically connected to the transmission line 402C-2 by the conductive vias 414C-2 having a vertical height H4 that is the same or different than vertical height H3. In some embodiments, the transmission line 402C-1 of the feeding element 400C-1 and the transmission line 402C-2 of the feeding element 400C-2 are asymmetric in the geometric configuration of the levels of distribution. In some embodiments, the conductive vias 404C-1 and 414C-1 of the feeding element 400C-1 and the conductive vias 404C-2 and 414C-2 of the feeding element 400C-2 are asymmetric in the geometric configuration of the vertical heights.

As shown in FIG. 3D, the feeding element 400D includes a pair of feeding elements 400D-1 and 400D-2. The transmission line of the feeding element 400D-1 may be a single-layer structure. The transmission line of the feeding element 400D-2 may be composed of segments positioned at different levels. For example, the feeding element 400D-1 may include a single transmission line 402D-1 and a conductive via 404D-1. The transmission line 402D-1 is positioned at the levels L2. The transmission line 402D-1 is electrically connected to the feeding port 200-1 by the conductive via 404D-1 having a vertical height of H1. For example, the feeding element 400D-2 may include a transmission line 402D-2 and conductive vias 404D-2 and 414D-2. In some embodiments, the transmission line 402D-2 includes segments 402D-2A and 402D-2B positioned at different levels L3 and L1, and the conductive via 414D-2 having a vertical height H5 connected between segments 402D-2A and 402D-2B. The vertical height H5 may be the same as or different than vertical height H1 and/or vertical height H2. Therefore, a feeding starting portion 402DS-2A and a feeding ending portion 402DE-2B are located at the ends of segments 402D-2A and 402D-2B, which are away from the conductive via 414D-2. The transmission line 402D-2 is electrically connected to the feeding port 200-2 by the conductive via 404D-2 having a vertical height H2 that is different than vertical height H1. The segments 402D-2A and 402D-2B positioned at levels L3 and L1 may alternate with the transmission line 402D-1 positioned at level L2. Therefore, the transmission line 402D-1 may be disposed between segments 402D-2A and 402D-2B in the z-direction. In some embodiments, the transmission line 402D-1 of the feeding element 400D-1 and the transmission line 402D-2 of the feeding element 400D-2 are asymmetric in the geometric configuration of the levels of distribution. In some embodiments, the conductive via 404D-1 of the feeding element 400D-1 and the conductive vias 404D-2 and 414D-2 of the feeding element 400D-2 are asymmetric in the geometric configuration of the vertical heights.

As shown in FIG. 3E, the feeding element 400E includes a pair of feeding elements 400E-1 and 400E-2. The transmission line of the feeding element 400E-1 may be a single-layer structure. The transmission line of the feeding element 400E-2 may be a dual-layer structure. For example, the feeding element 400E-1 may include a single transmission line 402E-1 and a conductive via 404E-1. The configurations of the transmission line 402E-1 and the conductive via 404E-1 may be similar to those of the transmission line 402D-1 and the conductive via 404D-1 of the feeding element 400D-1. For example, the feeding elements 400E-2 may include transmission lines 402E-2 and 412E-2 and conductive vias 404E-2 and 414E-2. The configurations of the transmission lines 402E-2 and 412E-2 and the conductive vias 404E-2 and 414E-2 may be similar to those of the transmission lines 402C-2 and 412C-2 and the conductive vias 404A-2 and 414C-2 of the feeding element 400C-1. Therefore, the transmission line 402E-1 may be disposed between the transmission lines 402E-2 and 412E-2 in the z-direction. In some embodiments, the transmission line 402E-1 of the feeding element 400E-1 and the transmission lines 402E-2 and 412E-2 of the feeding element 400E-2 are asymmetric in the geometric configuration of the levels of distribution. In some embodiments, the conductive via 404E-1 of the feeding element 400E-1 and the conductive vias 404E-2 and 414E-2 of the feeding element 400E-2 are asymmetric in the geometric configuration of the vertical heights.

As shown in FIG. 3F, the feeding element 400F includes a pair of feeding elements 400E-1 and 400E-2. The transmission line of the feeding element 400E-1 may be a single-layer structure. The transmission line of the feeding element 400E-2 may be composed of segments positioned at different levels. In addition, the transmission lines of the feeding elements 400E-1 and 400E-2 are electrically connected to the corresponding pair of radiators 100-1 and 100-2 by conductive vias. For example, the feeding element 400E-1 may include a single transmission line 402F-1 and a conductive via 404F-1. As shown in FIGS. 3E and 3F, the difference between the feeding elements 400E-1 and 400E-1 is that the feeding element 400E-1 further includes a conductive via 424F-1 having a vertical height H6 directly connected between the transmission line 402F-1 and the radiator 100-2. For example, the feeding element 400E-2 may include a transmission line 402F-2 and conductive vias 404F-2 and 414F-2. In some embodiments, the transmission line 402F-2 includes segments 402F-2A and 402F-2B positioned at different levels L3 and L1, and the conductive via 414F-2 having a vertical height H5 connected between segments 402F-2A and 402F-2B. The difference between the feeding elements 400D-2 and 400E-2 is that the feeding element 400E-2 further includes a conductive via 424F-2 having a vertical height H7 directly connected between the transmission line 402F-1 and the radiator 100-2. In some embodiments, the vertical height H7 may be different from the vertical height H6. In some embodiments, the transmission line 402F-1 of the feeding element 400E-1 and the transmission line 402F-2 of the feeding element 400E-2 are asymmetric in the geometric configuration of the levels of distribution. In some embodiments, the conductive vias 404F-1 and 424F-1 of the feeding element 400E-1 and the conductive vias 404F-2 and 424F-2 of the feeding element 400E-2 are asymmetric in the geometric configuration of the vertical heights.

As shown in FIG. 3G, the feeding element 400G includes a pair of feeding elements 400G-1 and 400G-2. The transmission line of the feeding element 400G-1 may be a single-layer structure. The transmission line of the feeding element 400G-2 may be a dual-layer structure. For example, the feeding element 400G-1 may include a single transmission line 402G-1 and a conductive via 404G-1. The configurations of the transmission line 402G-1 and the conductive via 404G-1 may be similar to those of the transmission line 402D-1 and the conductive via 404D-1 of the feeding element 400D-1. For example, the feeding elements 400G-2 may include transmission lines 402G-2 and 412G-2 and a conductive vias 404G-2 and 414G-2. The difference between the feeding elements 400C-2 and 400E-2 is that the feeding element 400G-2 includes the single conductive vias 404G-2 connected between the transmission lines 402G-2 and 412G-2, leaving an end of the transmission line 412G-2 being free from connected to the conductive via. In some embodiments, the transmission line 402G-1 of the feeding element 400G-1 and the transmission lines 402G-2 and 412G-2 of the feeding element 400G-2 are asymmetric in the geometric configuration of the levels of distribution. In some embodiments, the conductive via 404G-1 of the feeding element 400G-1 and the conductive vias 404G-2 and 424G-2 of the feeding element 400G-2 are asymmetric in the geometric configuration of the vertical heights.

As shown in FIG. 3H, the feeding element 400H includes a pair of feeding elements 400H-1 and 400H-2. The transmission line of each of the feeding elements 400H-1 and 400H-2 may be a single-layer structure. In addition, the feeding ports 200-1 and 200-2 are away from the geometric origin p0 by different distances in the plan view, wherein the geometric origin p0 may be a middle point of the gap (i.e., an intersection of the gaps GP1 and GP2). For example, the feeding element 400H-1 may include a single transmission line 402H-1 and a conductive via 404H-1. The configurations of the transmission line 402H-1 and the conductive via 404H-1 may be similar to those of the transmission line 402D-1 and the conductive via 404D-1 of the feeding element 400D-1. For example, the feeding element 400H-2 may include a single transmission line 402H-2 at the level L3 and a conductive via 404H-2 connected between the feeding port 200-2 and the transmission line 402H-2. In some embodiments, a distance d5 between the projection of the geometric origin p0 and a projection of the conductive via 404H-1 on xy-plane is different from a distance d6 between the projection of the geometric origin p0 and a projection of the conductive via 404H-2 on xy-plane (the distances d5 and d6 are labeled in the side view shown in FIG. 3H). Therefore, the feeding element 400H-1 and the feeding element 400H-2 may have asymmetric lateral distribution relative to the geometric origin p0 in the plan view. In addition, a feeding starting portion 402HS-1 (or a feeding ending portion 402HE-1) of the feeding element 400H-1 and a feeding starting portion 402HS-2 (or a feeding ending portion 402HE-2) of the feeding element 400H-2 may spaced apart the geometric origin p0 by different distances in the plan view. In some embodiments, the transmission line 402H-1 of the feeding element 400H-1 and the transmission line 402H-2 of the feeding element 400H-2 are asymmetric in the geometric configuration of the levels of distribution and the lateral distribution relative to the geometric origin p0 in the plan view. In some embodiments, the conductive via 404H-1 of the feeding element 400H-1 and the conductive via 404H-2 of the feeding element 400H-2 are asymmetric in the geometric configuration of the vertical heights and the lateral distribution relative to the geometric origin p0 in the plan view.

As shown in FIG. 3I, the feeding element 400I includes a pair of feeding elements 400I-1 and 400I-2. The transmission line of the feeding element 400I-1 may be a single-layer structure. The transmission line of the feeding element 400I-2 may be a dual-layer structure. For example, the feeding element 400I-1 may include a single transmission line 402I-1 and conductive vias 404I-1 and 4241-1. The configurations of the transmission line 402I-1 and the conductive vias 404I-1 and 4241-1 of the feeding element 400I-1 may be similar to those of the transmission line 402F-1 and the conductive vias 404F-1 and 424F-1 of the feeding element 400F1. For example, the feeding elements 400I-2 may include transmission lines 402I-2 and 412I-2 and a conductive vias 404I-2 and 414I-2. The configurations of the transmission lines 402I-2 and 412I-2 and the conductive vias 404I-2 and 4141-2 of the feeding element 400I-2 may be similar to those of the transmission lines 402G-2 and 412G-2 and the conductive vias 404G-2 and 414G-2 of the feeding element 400G2. In some embodiments, the transmission line 402I-1 of the feeding element 400I-1 and the transmission lines 402I-2 and 412I-2 of the feeding element 400I-2 are asymmetric in the geometric configuration of the levels of distribution. In some embodiments, the conductive vias 404I-1 and 424I-1 of the feeding element 400I-1 and the conductive vias 404I-2 and 414I-2 of the feeding element 400I-2 are asymmetric in the geometric configuration of the vertical heights.

In some embodiments, the transmission lines and the conductive vias of another pair of feeding elements in the feeding elements 400A-400I electrically connected to the feeding ports 200-3 and 200-4 (FIGS. 2A and 2B) and corresponding to the radiators 100-3 and 100-4 (FIGS. 2A and 2B) may have configurations similar to the configurations shown in any of FIGS. 3A and 3I and the details are not repeated herein for brevity.

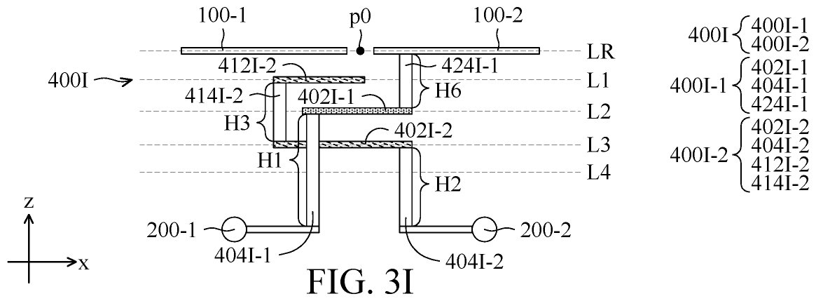

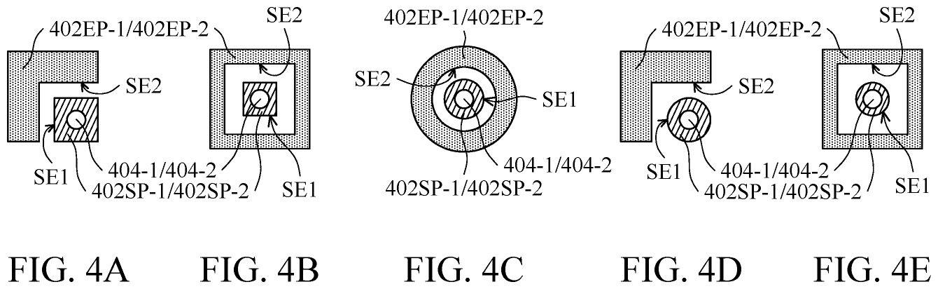

In some embodiments, the geometric configuration of the pair of feeding elements 400-1 and 400-2 (or the pair of feeding elements 400-3 and 400-4) are asymmetric in the geometric configuration of the shapes of the feeding starting portion and corresponding feeding ending portion connected to different feeding ports 200-1 and 200-2 (or the feeding ports 200-3 and 200-4). In addition, the feeding starting portion and corresponding feeding ending portion of the pair of feeding elements 400-1 and 400-2 (or the pair of feeding elements 400-3 and 400-4) connected to different feeding ports 200-1 and 200-2 (or the feeding ports 200-3 and 200-4) may have quasi-complementary shapes. FIGS. 4A, 4B, 4C, 4D and 4E are plan views of portions of feeding elements 400, showing configurations of the feeding starting portions 402SP-1, 402SP-2 and the feeding ending portions 402EP-1, 402EP-2 of the transmission lines 402-1, 402-2 of the pair of feeding elements 400-1, 400-2 of the antenna 500 in accordance with some embodiments of the disclosure. Elements of the embodiments hereinafter, that are the same or similar as those previously described with reference to FIGS. 2A to 2C, are not repeated for brevity. It should be appreciated that although some features are shown in some embodiments but not in other embodiments, these features may (or may not) exist in other embodiments whenever possible. For example, although each of the illustrated example embodiments shows specific arrangements of the feeding starting portions and the feeding ending portions, any other combinations of arrangements of the feeding starting portions and the feeding ending portions may also be used whenever applicable.

As shown in FIG. 4A, the feeding starting portion 402SP-1 connected to the feeding port 200-1 (or the feeding starting portion 402SP-2 connected to the feeding port 200-2) may have a square shape, and the corresponding feeding ending portion 402EP-2 connected to the feeding port 200-2 (or the feeding ending portion 402EP-1 connected to the feeding port 200-1) may have an inverse L-shape. In some embodiments, the feeding starting portion 402SP-1 (or the feeding starting portion 402SP-2) is partially surrounded by the corresponding feeding ending portion 402EP-2 (or the feeding ending portion 402EP-1) in the plan view. In addition, an outer edge SE1 of the feeding starting portion 402SP-1 (or the feeding starting portion 402SP-2) may corresponding to an inner edge SE2 of the corresponding feeding ending portion 402EP-2 (or the feeding ending portion 402EP-1).

As shown in FIG. 4B, the feeding starting portion 402SP-1 connected to the feeding port 200-1 (or the feeding starting portion 402SP-2 connected to the feeding port 200-2) may have a square shape, and the corresponding feeding ending portion 402EP-2 connected to the feeding port 200-2 (or the feeding ending portion 402EP-1 connected to the feeding port 200-1) may have a square ring shape. In some embodiments, the feeding starting portion 402SP-1 (or the feeding starting portion 402SP-2) is fully surrounded by the corresponding feeding ending portion 402EP-2 (or the feeding ending portion 402EP-1). In addition, the outer edge SE1 of the feeding starting portion 402SP-1 (or the feeding starting portion 402SP-2) may corresponding to the inner edge SE2 of the corresponding feeding ending portion 402EP-2 (or the feeding ending portion 402EP-1).

As shown in FIG. 4C, the feeding starting portion 402SP-1 connected to the feeding port 200-1 (or the feeding starting portion 402SP-2 connected to the feeding port 200-2) may have a circular shape, and the corresponding feeding ending portion 402EP-2 connected to the feeding port 200-2 (or the feeding ending portion 402EP-1 connected to the feeding port 200-1) may have a circular ring shape. In some embodiments, the feeding starting portion 402SP-1 (or the feeding starting portion 402SP-2) is fully surrounded by the corresponding feeding ending portion 402EP-2 (or the feeding ending portion 402EP-1). In addition, the outer edge SE1 of the feeding ending portion 402SP-1 (or the feeding starting portion 402SP-2) may corresponding to the inner edge SE2 of the corresponding feeding ending portion 402EP-2 (or the feeding ending portion 402EP-1).

As shown in FIG. 4D, the feeding starting portion 402SP-1 connected to the feeding port 200-1 (or the feeding starting portion 402SP-2 connected to the feeding port 200-2) may have a circular shape, and the corresponding feeding ending portion 402EP-2 connected to the feeding port 200-2 (or the feeding ending portion 402EP-1 connected to the feeding port 200-1) may have an inverse L-shape. In some embodiments, the feeding starting portion 402SP-1 (or the feeding starting portion 402SP-2) is partially surrounded by the corresponding feeding ending portion 402EP-2 (or the feeding ending portion 402EP-1). In addition, the outer edge SE1 of the feeding starting portion 402SP-1 (or the feeding starting portion 402SP-2) may corresponding to the inner edge SE2 of the corresponding feeding ending portion 402EP-2 (or the feeding ending portion 402EP-1).

As shown in FIG. 4E, the feeding starting portion 402SP-1 connected to the feeding port 200-1 (or the feeding starting portion 402SP-2 connected to the feeding port 200-2) may have a circular shape, and the corresponding feeding ending portion 402EP-2 connected to the feeding port 200-2 (or the feeding ending portion 402EP-1 connected to the feeding port 200-1) may have a square ring shape. In some embodiments, the feeding starting portion 402SP-1 (or the feeding starting portion 402SP-2) is fully surrounded by the corresponding feeding ending portion 402EP-2 (or the feeding ending portion 402EP-1). In addition, the outer edge SE1 of the feeding ending portion 402SP-1 (or the feeding starting portion 402SP-2) may corresponding to the inner edge SE2 of the corresponding feeding ending portion 402EP-2 (or the feeding ending portion 402EP-1). However, the shapes of the feeding starting portion 402SP-1 (or the feeding starting portion 402SP-2) and the corresponding feeding ending portion 402EP-2 (or the feeding ending portion 402EP-1) are not limited to the disclosed embodiments.

In some embodiments, the feeding starting portion 402SP-1 (or the feeding starting portion 402SP-2) and the corresponding feeding ending portion 402EP-2 (or the feeding ending portion 402EP-1) are positioned at the same level or different levels. In addition, the feeding starting portion 402SP-1 (or the feeding starting portion 402SP-2) may not overlap the corresponding feeding ending portion 402EP-2 (or the feeding ending portion 402EP-1) in the plan view (FIGS. 4A-4E).

In some embodiments, the shapes of the feeding starting portion 402SP-3 (or the feeding starting portion 402SP-4) and corresponding feeding ending portion 402EP-3 (or the feeding ending portion 402EP-4) of the pair of feeding elements 400-3 and 400-4 connected to different feeding ports 200-3 and 200-4 (FIGS. 2A and 2B) may be the same or similar as those of the feeding starting portion 402SP-1 (or the feeding starting portion 402SP-2) and the feeding ending portion 402EP-2 (or the feeding ending portion 402EP-1) of the pair of feeding elements 400-1 and 400-2 and the details are not repeated herein for brevity.

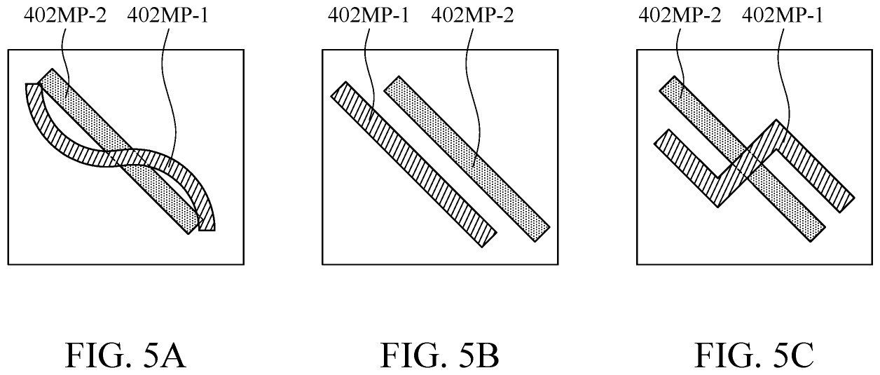

In some embodiments, the geometric configuration of the pair of feeding elements 400-1 and 400-2 (or the pair of feeding elements 400-3 and 400-4) are asymmetric in the geometric configuration of the shapes of the feeding middle portions. FIGS. 5A, 5B and 5C are plan views of portions of feeding elements 400, showing configurations of feeding middle portions 402MP-1, 402MP-2 of the transmission lines 402-1, 402-2 of the pair of feeding elements 400-1, 400-2 of the antenna 500 in accordance with some embodiments of the disclosure. Elements of the embodiments hereinafter, that are the same or similar as those previously described with reference to FIGS. 2A to 2C, are not repeated for brevity. It should be appreciated that although some features are shown in some embodiments but not in other embodiments, these features may (or may not) exist in other embodiments whenever possible. For example, although each of the illustrated example embodiments shows specific arrangements of the feeding middle portions, any other combinations of arrangements of the feeding middle portions may also be used whenever applicable.

As shown in FIG. 5A, the feeding middle portion 402MP-1 may have a meander line shape, and the corresponding feeding middle portion 402MP-2 may have a straight line shape. In some embodiments, the feeding middle portion 402MP-1 and the feeding middle portion 402MP-2 positioned at different levels may partially overlap each other in the plan view shown in FIG. 5A.

As shown in FIG. 5B, the feeding middle portion 402MP-1 and the corresponding feeding middle portion 402MP-2 may both have a straight line shape. The feeding middle portion 402MP-1 and the feeding middle portion 402MP-2 may be parallel to and separated from each other. In some embodiments, the feeding middle portion 402MP-1 and the feeding middle portion 402MP-2 may be positioned side-by-side at the same level or different levels without overlapping each other in the plan view shown in FIG. 5B.

As shown in FIG. 5C, the feeding middle portion 402MP-1 may have a zigzag shape, and the corresponding feeding middle portion 402MP-2 may have a straight line shape. In some embodiments, the feeding middle portion 402MP-1 and the feeding middle portion 402MP-2 positioned at different levels may partially overlap each other in the plan view shown in FIG. 5C. However, the shapes of the feeding middle portion 402MP-1 and the feeding middle portion 402MP-2 are not limited to the disclosed embodiments.

In some embodiments, the shapes of the feeding middle portion 402MP-3 and corresponding feeding middle portion 402MP-4 of the pair of feeding elements 400-3 and 400-4 connected to different feeding ports 200-3 and 200-4 (FIGS. 2A and 2B) may be the same or similar as those of the feeding middle portion 402MP-1 and the feeding middle portion 402MP-2 of the pair of feeding elements 400-1 and 400-2 and the details are not repeated herein for brevity.

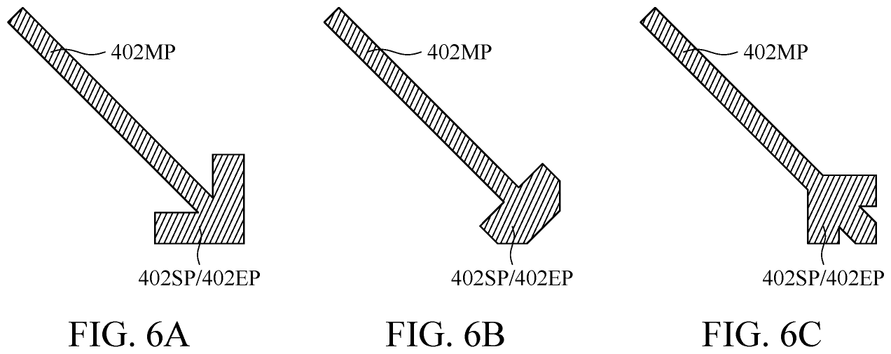

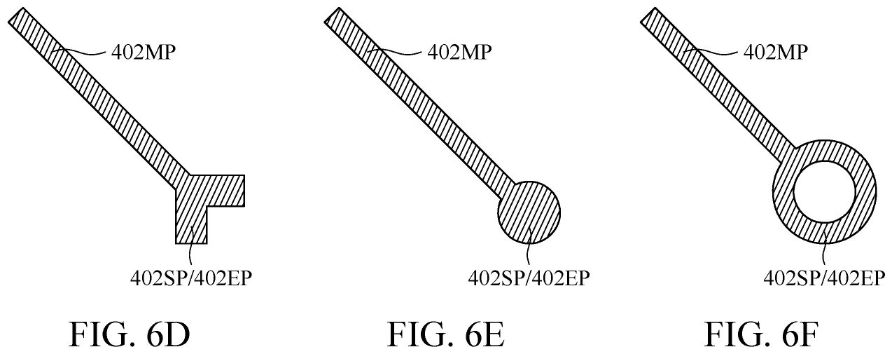

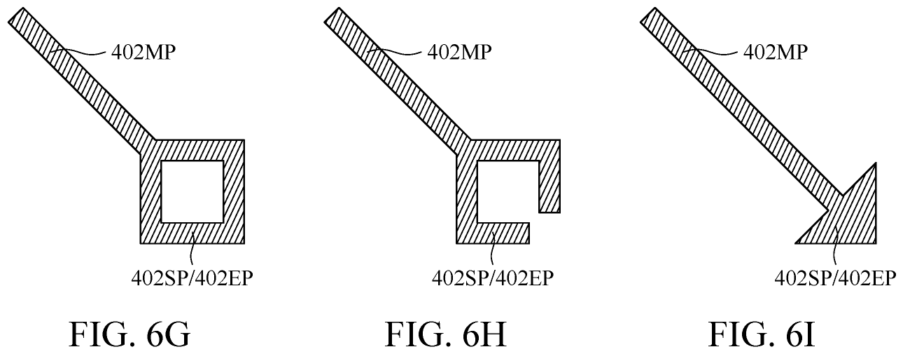

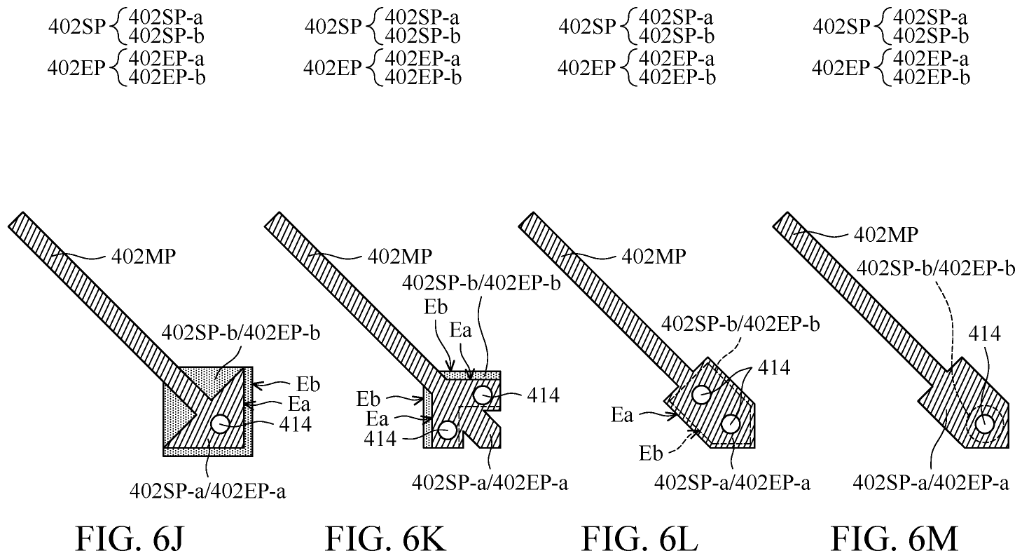

FIGS. 6A, 6B, 6C, 6D, 6E, 6F, 6G, 6H, 6I, 6J, 6K, 6L and 6M are plan views of portions of feeding elements 400, showing configurations of the feeding starting portion 402SP (or the feeding ending portion 402EP) of the transmission lines 402-1 to 402-4 of the feeding elements 400-1 to 400-4 of the antenna 500 in accordance with some embodiments of the disclosure. Elements of the embodiments hereinafter, that are the same or similar as those previously described with reference to FIGS. 2A-2C, 4A-4E and 5A-5C, are not repeated for brevity. It should be appreciated that although some features are shown in some embodiments but not in other embodiments, these features may (or may not) exist in other embodiments whenever possible. For example, although each of the illustrated example embodiments shows specific arrangements of the feeding starting portions, the feeding middle portions and the feeding ending portions, any other combinations of arrangements of the feeding starting portions, the feeding middle portions and the feeding ending portions shown in previous figures may also be used whenever applicable.

In some embodiments, the feeding starting portion 402SP-1 (or the feeding ending portion 402EP-1) of the transmission line 402-1 may be a single-layer structure (FIGS. 6A to 6I) or a dual-layer structure (FIGS. 6J to 6M). In some embodiments, the feeding starting portion 402SP (or the feeding ending portion 402EP) of the transmission lines 402-1 to 402-4 may have a shape comprising a triangle shape (FIGS. 6I and 6J), a polygonal shape (for example, a square shape in FIG. 6J, a pentagonal shape in FIGS. 6L and 6M and a hexagonal shape in FIG. 6B), an inverse L-shape (FIGS. 6D and 6K), a reverse L-shape (FIG. 6A), a fork-shape (including a trident shape) (FIGS. 6C and 6K), a circular shape (FIG. 6E), a closed circular ring shape (FIG. 6F), an open circular ring shape, a closed polygonal ring shape (for example, a closed square ring shape in FIG. 6G), an open polygonal ring shape (for example, a open square ring shape in FIG. 6H) or other suitable shapes.

In some embodiments in which the feeding starting portion 402SP (or the feeding ending portion 402EP) of the transmission lines 402-1 to 402-4 is a dual-layer structure (FIGS. 6J to 6M), the feeding starting portion 402SP (or the feeding ending portion 402EP) may include sub-portions 402SP-a and 402SP-b (or sub-portions 402EP-a and 402EP-b) at different levels and connected to each other by one or more conductive vias 414. In addition, the sub-portions 402SP-a and 402SP-b may overlap each other in the plan view. In some embodiments, the sub-portions 402SP-a and 402SP-b may have the same or different shapes in the plan view. For example, the sub-portion 402SP-a may have a triangle shape and the sub-portion 402SP-b may have a square shape as shown in FIG. 6J. The sub-portion 402SP-a may have a fork-shape and the sub-portion 402SP-b may have an inverse L-shape as shown in FIG. 6K. The sub-portion 402SP-1a and the sub-portion 402SP-b may both have a pentagonal shape as shown in FIG. 6L. In addition, the sub-portion 402SP-a may have a pentagonal shape and the sub-portion 402SP-b may have a circular shape as shown in FIG. 6M. In some embodiments, the sub-portion 402SP-a may have one or more edges Ea corresponding to one or more edges Eb of the sub-portion 402SP-b, as shown in FIGS. 6J to 6L.

It should be noted that the feeding middle portions 402MP of the transmission lines 402-1 and 402-2 (or the transmission lines 402-3 and 402-4) of the pair of feeding elements 400-1 and 400-2 (or the pair of feeding elements 400-3 and 400-4) connected to different feeding ports 200-1 and 200-2 (or the feeding ports 200-3 and 200-4) may have asymmetric configurations as shown in FIGS. 5A to 5C.

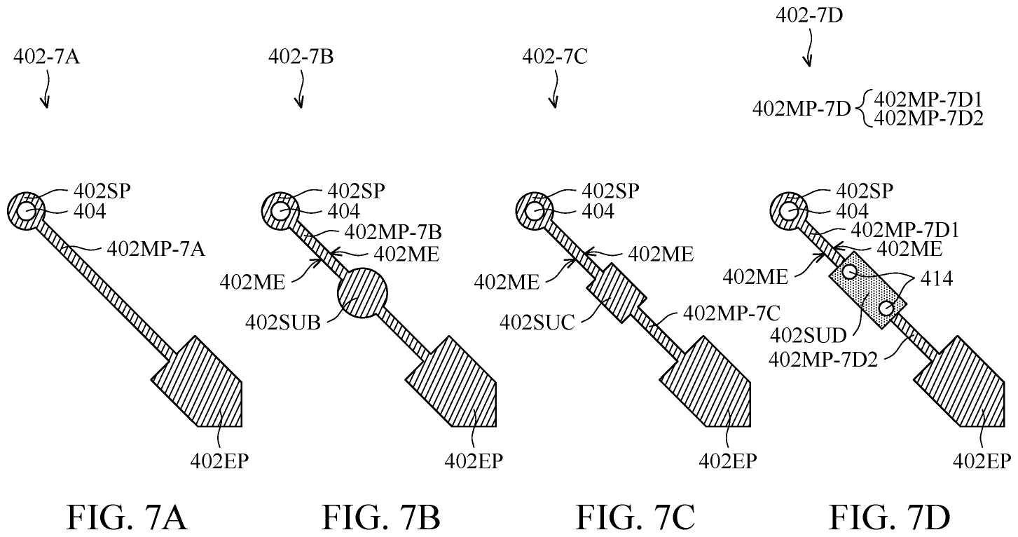

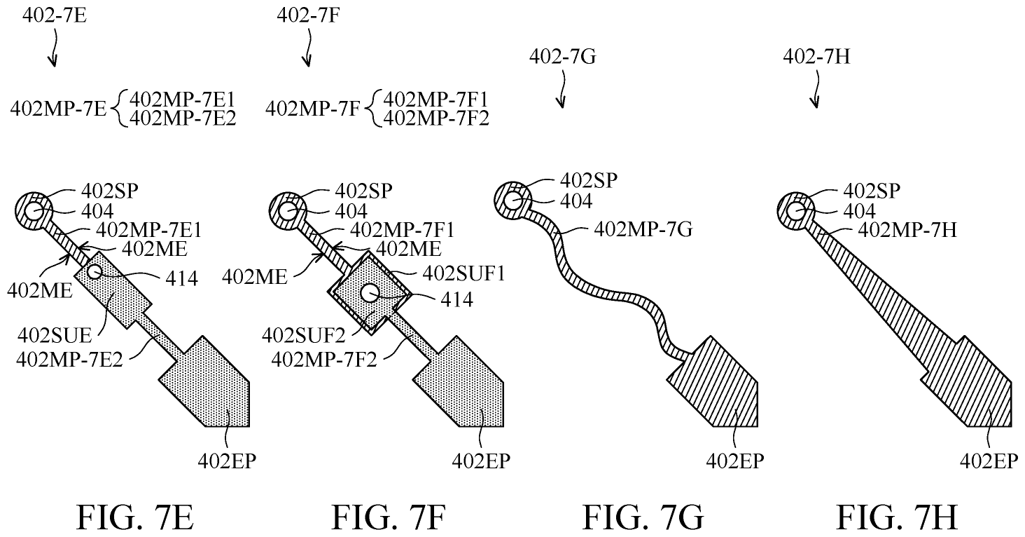

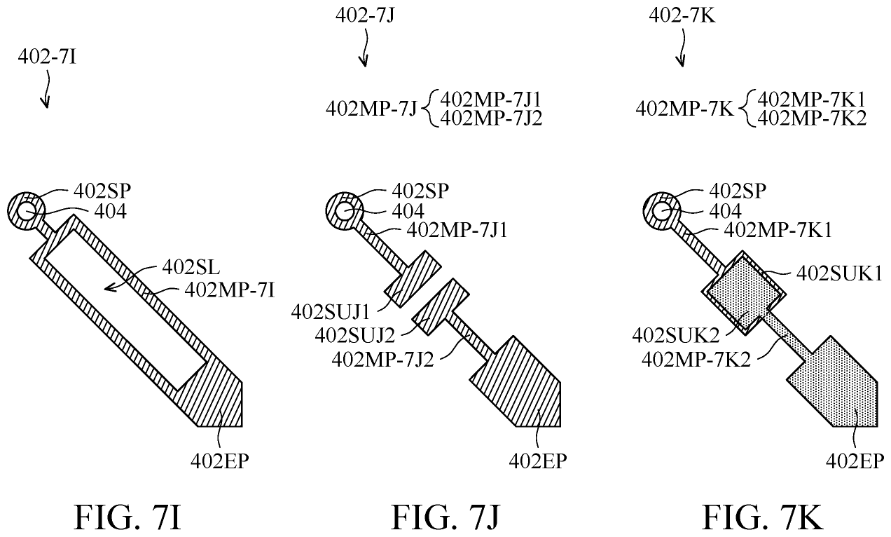

FIGS. 7A, 7B, 7C, 7D, 7E, 7F, 7G, 7H, 7I, 7J and 7K are plan views of portions of feeding elements 400, showing configurations of feeding middle portions 402MP-7A, 402MP-7B, 402MP-7C, 402MP-7D, 402MP-7E, 402MP-7F, 402MP-7G, 402MP-7H, 402MP-7I, 402MP-7J and 402MP-7K of transmission lines 402-7A, 402-7B, 402-7C, 402-7D, 402-7E, 402-7F, 402-7G, 402-7H, 402-7I, 402-7J and 402-7K of the feeding element 400 of the antenna 500 in accordance with some embodiments of the disclosure. In FIGS. 7A to 7K, the feeding starting portion 402SP may have a circular shape and the feeding ending portion 402EP may have a pentagonal shape for an example. However, the shapes of the feeding starting portion 402SP and the feeding ending portion 402EP are not limited to the disclosed embodiments. Elements of the embodiments hereinafter, that are the same or similar as those previously described with reference to FIGS. 2A-2C, 4A-4E, 5A-5C and 6A-6M, are not repeated for brevity. It should be appreciated that although some features are shown in some embodiments but not in other embodiments, these features may (or may not) exist in other embodiments whenever possible. For example, although each of the illustrated example embodiments shows specific arrangements of the feeding starting portions, the feeding middle portions and the feeding ending portions, any other combinations of arrangements of the feeding starting portions, the feeding middle portions and the feeding ending portions shown in previous figures may also be used whenever applicable.

In some embodiments, the feeding middle portions may be a single-layer structure (FIGS. 7A-7C and 7G-7J) or a dual-layer structure (FIGS. 7D-7F and 7K). In some embodiments in which the feeding middle portion is a single-layer structure, the feeding middle portion has a shape comprising a straight line shape (e.g., the feeding middle portion 402MP-7A of the transmission line 402-7A shown in FIG. 7A and the feeding middle portion 402MP-7I of the transmission line 402-7I shown in FIG. 7I), a meander line shape (e.g., the feeding middle portion 402MP-7G of the transmission line 402-7G shown in FIG. 7G), a taper line shape (e.g., the feeding middle portion 402MP-7H of the transmission line 402-7H shown in FIG. 7H) or a zigzag shape (e.g., the feeding middle portion 402MP-1 shown in FIG. 5C). As shown in FIG. 7I, the straight line shaped feeding middle portion 402MP-7I may have a slit 402SL formed within.

In some embodiments, the feeding middle portion of the transmission line may have a sub-portion that protrudes from the side surfaces of the feeding middle portion for impedance matching. Therefore, the widths of the feeding middle portion and the sub-portion are stepwise increased. It should be noted that the width of the feeding middle portion and the sub-portion of the transmission line herein refers to the distance between opposite sidewalls of the feeding middle portion and the sub-portion in a direction that is perpendicular to the extending direction of the transmission line. In some embodiments in which the feeding middle portion is a single-layer structure (FIGS. 7B and 7C), the feeding middle portion 402MP-7B of the transmission line 402-7B may have a circular-shaped sub-portion 402SUB that protrudes from the side surfaces 402ME of the feeding middle portion 402MP-7B as shown in FIG. 7B. The feeding middle portion 402MP-7C of the transmission line 402-7C may have a square-shaped sub-portion 402SUC that protrudes from the side surfaces 402ME of the feeding middle portion 402-7C, as shown in FIG. 7C.

In some embodiments in which the feeding middle portion is a dual-layer structure (FIGS. 7D to 7F), the feeding middle portion and the sub-portion may be positioned at the same or different levels (the different levels includes adjacent levels or non-adjacent levels). In addition, the feeding middle portion may include several segments at the same or different levels and connected to the sub-portion directly or indirectly. As shown in FIG. 7D, the feeding middle portion 402MP-7D of the transmission line 402-7C may include segments 402MP-7D1 and 402MP-7D2 at the same level and separated from each other. The segment 402MP-7D1 is connected to the feeding starting portion 402SP. The segment 402MP-7D2 is connected to the feeding ending portion 402EP. The feeding middle portion 402MP-7D may further have a square-shaped sub-portion 402SUD that protrudes from the side surfaces 402ME of the feeding middle portion 402MP-7D. In some embodiments, the sub-portion 402SUD is positioned at a different level than segments 402MP-7D1 and 402MP-7D2. In addition, the sub-portion 402SUD is electrically connected segments 402MP-7D1 and 402MP-7D2 by conductive vias 414.

As shown in FIG. 7E, the feeding middle portion 402MP-7E of the transmission line 402-7E may include segments 402MP-7E1 and 402MP-7E2 at different levels and separated from each other. The difference between the feeding middle portions 402MP-7D and 402MP-7E is that the feeding middle portion 402MP-7E may further have a square-shaped sub-portion 402SUE. The sub-portion 402SUE and the segment 402MP-7E2 are positioned at the same level and directly connected to each other. In addition, the sub-portion 402SUE is electrically connected to the segment 402MP-7E1 by the conductive via 414.

As shown in FIG. 7F, the feeding middle portion 402MP-7F of the transmission line 402-7F may include a segments 402MP-7F1 and 402MP-7F2 at different levels and separated from each other. The difference between the feeding middle portions 402MP-7E and 402MP-7F is that the feeding middle portion 402MP-7F may further have square-shaped sub-portions 402SUF1 and 402SUF2. The sub-portion 402SUF1 and the segment 402MP-7F1 are positioned at the same level and directly connected to each other. The sub-portion 402SUF2 and the segment 402MP-7F2 are positioned at the same level and directly connected to each other. In addition, the sub-portions 402SUF1 and 402SUF2 are electrically connected to each other by the conductive via 414.

In some embodiments, the feeding middle portion includes separated segments electrically connected to each other by electrically coupling. As shown in FIG. 7J, the feeding middle portion 402MP-7J of the transmission line 402-7J may include segments 402MP-7J1 and 402MP-7J2 at the same level and separated from each other. The feeding middle portion 402MP-7J may further have square-shaped sub-portions 402SUJ1 and 402SUJ2 connected to adjacent ends of segments 402MP-7J1 and 402MP-7J2. Therefore, the separated segments 402MP-7J1 and 402MP-7J2 may be electrically connected to each other by electrically coupling and configured to receive and/or transmit signals wirelessly.

As shown in FIG. 7K, the feeding middle portion 402MP-7K of the transmission line 402-7K may include segments 402MP-7K1 and 402MP-7K2 at different levels and separated from each other. The feeding middle portion 402MP-7K may further have square-shaped sub-portions 402SUK1 and 402SUK2 connected to adjacent ends of segments 402MP-7K1 and 402MP-7K2. Therefore, the separated segments 402MP-7K1 and 402MP-7K2 may be electrically connected to each other by electrically coupling and configured to receive and/or transmit signals wirelessly.

Embodiments provide an antenna for multi-broadband (e.g., dual-broadband) and multi-polarization (e.g., dual-polarization) communication. The antenna may include at least one pair of radiators, at least one pair of feeding elements, a first feeding port and a second feeding port. The pair of feeding elements includes a first feeding element and a second feeding element connected to the first and second feeding ports for feeding independent signals of different polarizations or bandwidths to the pair of radiators. In some embodiments, the pair of feeding elements has asymmetric geometric configurations. In some embodiments, the first feeding element has a first projection in a direction that is perpendicular to the pair of radiators. The second feeding element has a second projection in said direction. The first projection and the second projection partially overlap each other. In some embodiments, the pair of the feeding elements has quasi-complementary shapes to each other. For example, the first feeding element connected to the first feeding port may have a first feeding starting portion close to the first feeding port. The second feeding element connected to the second feeding port may have a second feeding ending portion surrounding the first feeding starting portion. In a plan view, the outer edge of the first feeding starting portion corresponds to the inner edge of the second feeding ending portion.

In some embodiments, the asymmetric geometric configurations of the pair of the feeding elements include the shape in the plan view, the levels of distribution, the distances from the projections of the feeding elements to the projection of the geometric origin on xy-plane, the distances from the projections of the feeding ports to the projection of the geometric origin on xy-plane or a combination thereof. In some embodiments, the shapes of feeding elements include the shapes of the feeding starting portion, the feeding middle portion and the feeding ending portion of the transmission line. In some embodiments, the transmission line includes separated segments and a conductive via connected between the segments, so that the feeding starting portion and the feeding ending portion are positioned at the ends of the separated segments that are away from the conductive via. In some embodiments, the feeding middle portion has a sub-portion protruding from the side surface of the feeding middle portion for impedance matching. In some embodiments, the feeding middle portion includes separated segments at the same or different levels. The segments of the feeding middle portion may be connected to the sub-portion by the conductive via. The segments of the feeding middle portion may be positioned at the same level and electrically connected to each other by electrically coupling.

In some embodiments, the antenna with multiple pairs of separated feeding elements in asymmetric feeding configurations may reduce port-to-port mutual coupling. The antenna efficiency and performances in both transmit and receive modes can be improved. The pair of the feeding elements having quasi-complementary shapes may reduce the overlapped area between the feeding elements for improvement of port-to-port isolation. Therefore, the isolation between the corresponding radiators operated in low-band and high-band or in vertical-polarization and horizontal-polarization can be improved. In addition, the separated feeding elements in asymmetric feeding configurations may have optimized design for the pair of corresponding radiators each operated in particular frequency/band or polarization. Therefore, the antenna gain can be improved.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna, comprising:
a pair of radiators comprising two radiators located beside a geometric origin and separated from each other, wherein the geometric origin is located between the radiators;
a pair of feeding elements located below the pair of radiators and configured to feed signals to the radiators, wherein the pair of feeding elements comprise a first feeding element and a second feeding element separated from each other, wherein the first feeding element has a first geometric configuration, and the second feeding element has a second geometric configuration asymmetric to the first geometric configuration;
a first feeding port electrically connected to the first feeding element; and
a second feeding port separated from the first feeding port and electrically connected to the second feeding element.

2. The antenna as claimed in claim 1, wherein the first and second geometric configurations comprise shapes of the first and second feeding elements, levels of distribution of the first and second feeding elements, distances from a projection of a feeding starting portion or a projection of a feeding ending portion of the first and second feeding elements to a projection of the geometric origin on xy-plane, or a combination thereof.

3. The antenna as claimed in claim 1, wherein the first feeding element comprises a first transmission line positioned at a first level and extending toward the second feeding port in a plan view, wherein the second feeding element comprises a second transmission line positioned at a second level and extending toward the first feeding port in a plan view, and wherein the second level is different from the first level.

4. The antenna as claimed in claim 3, wherein the first feeding element comprises a first conductive via with a first vertical height connected between the first feeding port and the first transmission line, and the second feeding element comprises a second conductive via with a second vertical height connected between the second feeding port and the second transmission line, and wherein the first vertical height is different from the second vertical height.

5. The antenna as claimed in claim 4, wherein:
the first transmission line has a first feeding starting portion and a first feeding ending portion at opposite ends of the first transmission line, wherein the first feeding starting portion is connected to the first conductive via, and wherein
the second transmission line has a second feeding starting portion and a second feeding ending portion at opposite ends of the second transmission line, wherein the second feeding starting portion is connected to the second conductive via.

6. The antenna as claimed in claim 5, wherein a first distance between a projection of the geometric origin and a projection of the first feeding starting portion on xy-plane is different from a second distance between the projection of the geometric origin and a projection of the second feeding starting portion on xy-plane.

7. The antenna as claimed in claim 5, wherein a third distance between a projection of the geometric origin and a projection of the first feeding ending portion on xy-plane is different from a fourth distance between the projection of the geometric origin and a projection of the second feeding ending portion on xy-plane.

8. The antenna as claimed in claim 3, wherein the first feeding element comprises:
a third transmission line positioned at a third level different from the first level; and
a third conductive via with a third vertical height connected between the first transmission line and the third transmission line.

9. The antenna as claimed in claim 4, wherein in a plan view, a fifth distance between a projection of the geometric origin and a projection of the first conductive via on xy-plane is different from a sixth distance between the projection of the geometric origin and a projection of the second conductive via on xy-plane.

10. The antenna as claimed in claim 5, wherein the first transmission line comprises:
a first segment positioned at the first level;
a second segment positioned at a fifth level different from the first and second levels; and
a sixth conductive via connected between the first segment and the second segment, wherein the first feeding starting portion and the first feeding ending portion are positioned at ends of the first segment and the second segment, and the first feeding starting portion and the first feeding ending portion are away from the sixth conductive via.

11. The antenna as claimed in claim 5, wherein in a plan view, the first feeding starting portion, the first feeding ending portion, the second feeding starting portion, and the second feeding ending portion have a triangle shape, a polygonal shape, an inverse L-shape, a reverse L-shape, a trident shape, a circular shape, a closed circular ring shape, an open circular ring shape, a closed polygonal ring shape or an open polygonal ring shape.

12. The antenna as claimed in claim 5, wherein the first feeding starting portion is surrounded by the second feeding ending portion in a plan view, and an outer edge of the first feeding starting portion corresponds to an inner edge of the second feeding ending portion in the plan view.

13. The antenna as claimed in claim 5, wherein:
the first transmission line has a first feeding middle portion interposed between the first feeding starting portion and the first feeding ending portion, wherein
the second transmission line has a second feeding middle portion interposed between the second feeding starting portion and the second feeding ending portion, and wherein first feeding middle portion is separated from the second feeding middle portion.

14. The antenna as claimed in claim 13, wherein the first feeding middle portion and the second feeding middle portion are positioned side-by-side at the same level.

15. The antenna as claimed in claim 13, wherein the first feeding middle portion and the second feeding middle portion are positioned at different levels, and the first feeding middle portion and the second feeding middle portion partially overlap in a plan view.

16. The antenna as claimed in claim 13, wherein the first feeding middle portion has a straight line shape, a meander line shape, a taper line shape or a zigzag shape.

17. The antenna as claimed in claim 13, wherein the first feeding middle portion has a sub-portion protruding from a side surface of the first feeding middle portion, and the first feeding middle portion and the sub-portion are positioned at different levels.

18. The antenna as claimed in claim 13, wherein the first feeding middle portion comprises:
a third segment connected to the first feeding starting portion; and
a fourth segment separated from the third segment and connected to the first feeding ending portion, wherein the third segment and the fourth segment are positioned at different levels.

19. The antenna as claimed in claim 13, wherein the first feeding middle portion comprises:
a third segment connected to the first feeding starting portion; and
a fourth segment separated from the third segment and connected to the first feeding ending portion, wherein the third segment and the fourth segment are positioned at the same level and are electrically connected to each other by electrically coupling.

20. An electronic device comprising an antenna, the antenna comprising:
a first pair of radiators, comprising a first radiator and a second radiator separated from each other;
a second pair of radiators, comprising a third radiator and a fourth radiator separated from each other;
wherein the first radiator and the third radiator are arranged at two opposite sides of a second gap, and the second radiator and the fourth radiator are arranged at two opposite sides of the second gap, and the first radiator and the fourth radiator are arranged at two opposite sides of a first gap, and the second radiator and the third radiator are arranged at two opposite sides of the first gap, and the first gap and the second gap are intersected,
a first pair of feeding elements located below the first pair of radiators and configured to feed signals to the first pair of radiators, wherein the first pair of feeding elements comprises a first feeding element and a second feeding element separated from each other, wherein the first feeding element has a first geometric configuration, and the second feeding element has a second geometric configuration asymmetric to the first geometric configuration; and
a second pair of feeding elements located below the second pair of radiators and configured to feed signals to the second pair of radiators, wherein the second pair of feeding elements comprises a third feeding element and a fourth feeding element separated from each other, wherein the third feeding element has a third geometric configuration, and the fourth feeding element has a fourth geometric configuration asymmetric to the third geometric configuration.
